(19) United States
(12) Patent Application Publication
(10) Pub. No.: US 2023/0283016 A1
(43) Pub. Date: Sep. 7, 2023

(54) TRANSCEIVER APPARATUS AND TRANSCEIVER MODULE

(71) Applicant: Delta Electronics, Inc., Taoyuan City (TW)

(72) Inventors: Li-Hua SU, Taoyuan City (TW); Tun-Chuan CHEN, Taoyuan City (TW); Chia-Lun KU, Taoyuan City (TW)

(21) Appl. No.: 17/844,820

(22) Filed: Jun. 21, 2022

(30) Foreign Application Priority Data
Mar. 3, 2022 (CN) 202220444858.7

(51) Int. Cl. H01R 13/633

(52) U.S. Cl. CPC H01R 13/6335

(57) ABSTRACT

A transceiver module includes a housing, a circuit board and a pull member. The housing has a received space and a guiding slot. The circuit board is disposed in the received space. The pull member is connected to the housing, and the pull member has a plate-shaped structure and an engaging structure. The plate-shaped structure extends along a long axis, and the engaging structure has a first curved portion connected to the plate-shaped structure. The plate-shaped structure forms two notches, and the engaging structure is located between the two notches.

### CROSS REFERENCE TO RELATED APPLICATIONS

This application claims the benefit of China Utility Model Application No. 202220444858.7, filed on Mar. 3, 2022, the entirety of which is incorporated by reference herein.

### BACKGROUND OF THE DISCLOSURE

### Field of the Disclosure

The present disclosure relates in general to a transceiver module, and it relates in particular to an easy-to-plug transceiver module.

### Description of the Related Art

In modern society, network-related optoelectronic communication products, such as switches and hubs, have become indispensable tools of everyday life. These devices usually contain one or more transmitter modules configured to convert optical signals into electrical signals so that optical fibers can be connected to network apparatus through a transmitter module.

Generally speaking, each transceiver module has a corresponding socket, so that the transceiver module can be quickly inserted into the socket or pulled out from the socket. In addition, in order to fix the inserted transceiver module, corresponding engaging structures are provided on the transceiver module and the socket, so that the inserted transceiver module can achieve the purpose of engagement. However, when the transceiver module is disposed at a certain height, the transceiver module can easily get stuck by the current engaging structures, and it is difficult to pull the transceiver module out.

Therefore, how to design a transceiver module that can be easily plugged in and unplugged is a topic worthy of discussion today.

### BRIEF SUMMARY OF THE DISCLOSURE

Accordingly, one objective of the present disclosure is to provide a transceiver module to solve the above problems.

According to some embodiments of the disclosure, the present disclosure provides a transceiver module including a housing, a circuit board and a pull member. The housing has an received space and a guiding slot. The circuit board is disposed in the received space. The pull member is connected to the housing, and the pull member has a plate-shaped structure and an engaging structure. The plate-shaped structure extends along a long axis, and the engaging structure has a first curved portion connected to the plate-shaped structure. The plate-shaped structure forms two notches, and the engaging structure is located between the two notches.

According to some embodiments, when viewed along a short axis, which is perpendicular to the long axis, the first curved portion overlaps the plate-shaped structure.

According to some embodiments, a radius of curvature of the first curved portion is greater than 0.75 mm. According to some embodiments, a width of the engaging structure in the short axis is between 2 mm and 3 mm.

According to some embodiments, the plate-shaped structure has a first side portion and a second side portion, and a total width of the first side portion and the second side portion in the short axis is less than half of a width of the plate-shaped structure in the short axis.

According to some embodiments, the two notches are formed between the first side portion and the second side portion.

According to some embodiments, a thickness of the engaging structure is non-uniform.

According to some embodiments, the engaging structure further has a second curved portion, and a radius of curvature of the second curved portion is different from a radius of curvature of the first curved portion.

According to some embodiments, the radius of curvature of the second curved portion is smaller than the radius of curvature of the first curved portion.

According to some embodiments of the disclosure, the present disclosure provides a transceiver apparatus which includes a socket and a transceiver module. The socket has a limiting structure. The transceiver module corresponds to the socket, and the transceiver module includes a housing, a circuit board and a pull member. The housing has an received space and a guiding slot, and the housing is configured to be inserted into the socket or pulled out from the socket. The circuit board is disposed in the received space and configured to be electrically connected to a connector in the socket. The pull member is connected to the housing, and the pull member has a plate-shaped structure and an engaging structure. The plate-shaped structure extends along a long axis, and the engaging structure has a first curved portion connected to the plate-shaped structure. The plate-shaped structure forms two notches, and the engaging structure is located between the two notches.

The present disclosure provides a transceiver apparatus, which includes a transceiver module and a socket that can be engaged with each other. The pull member of the transceiver module has at least one engaging structure configured to be engaged with the corresponding limiting structure on the socket. Two notches can be formed on the plate-shaped structure of the pull member, which are located on both sides of the engaging structure. This design can make the first curved portion of the engaging structure have a larger radius of curvature than that of the conventional designs.

Therefore, Based on the design of the present disclosure, the user can easily and smoothly pull out the transceiver module which is disposed at a certain height, without the problem that the conventional design is stuck and cannot be pulled out, and the required pulling force F can also be smaller than the conventional designs, allowing the user to easily pull out the transceiver module.

Additional features and advantages of the disclosure will be set forth in the description which follows, and, in part, will be obvious from the description, or can be learned by practice of the principles disclosed herein. The features and advantages of the disclosure can be realized and obtained by means of the instruments and combinations pointed out in the appended claims. These and other features of the disclosure will become more fully apparent from the following description and appended claims, or can be learned by the practice of the principles set forth herein.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a transceiver apparatus 50 according to an embodiment of the present disclosure.

FIG. 2 is an exploded diagram of the transceiver apparatus 50 according to an embodiment of the present disclosure.

FIG. 3 is a cross-sectional view of the transceiver apparatus 50 along the line A-A in FIG. 1 according to an embodiment of the present disclosure.

FIG. 4 is a schematic diagram illustrating that the transmitter module 100 is disconnected from the socket 200 according to an embodiment of the present disclosure.

FIG. 5 is an enlarged diagram of the pull member 108 when viewed along the second axis AX2 according to an embodiment of the present disclosure.

FIG. 6 is an enlarged diagram of the pull member 108 when viewed along a third axis AX3 according to an embodiment of the present disclosure.

FIG. 7 is a schematic diagram of a network apparatus 10 disposed on the ground according to an embodiment of the present disclosure.

### DETAILED DESCRIPTION OF THE ILLUSTRATIVE EMBODIMENTS

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

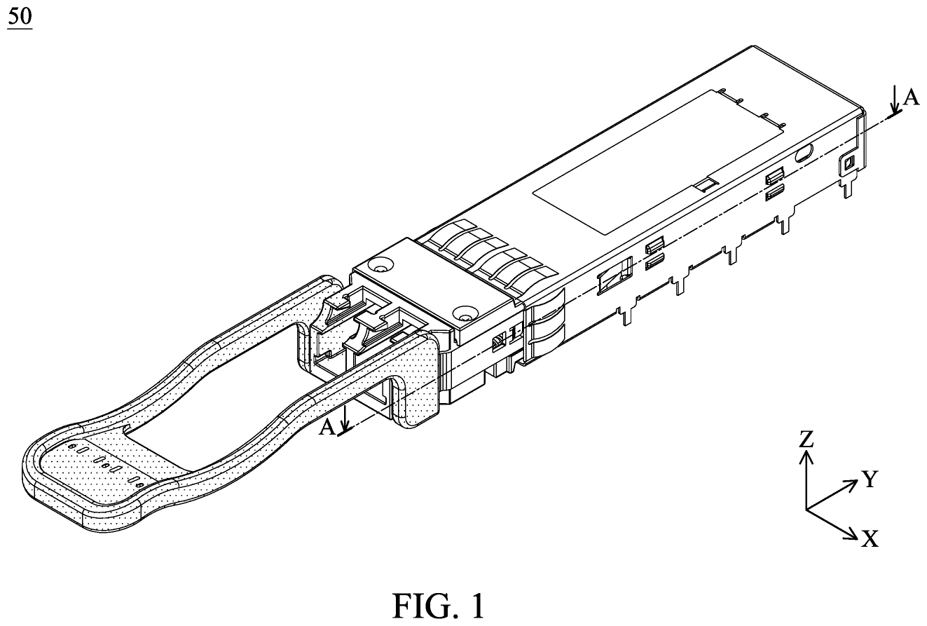

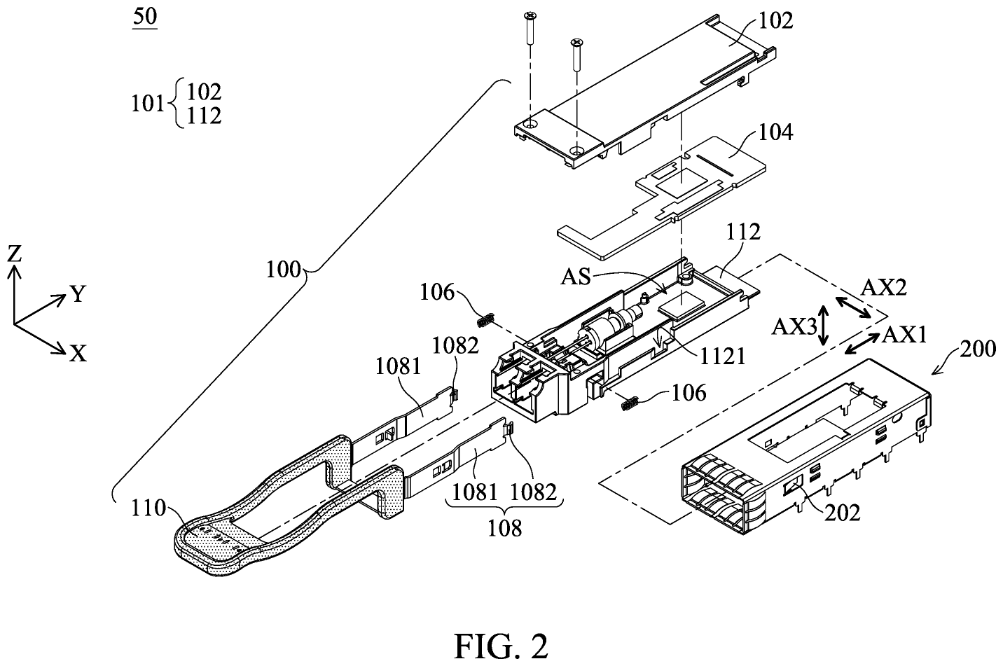

Please refer to FIG. 1 and FIG. 2. FIG. 1 is a schematic diagram of a transceiver apparatus 50 according to an embodiment of the present disclosure, and FIG. 2 is an exploded diagram of the transceiver apparatus 50 according to an embodiment of the present disclosure. In this embodiment, the transceiver apparatus 50 includes a transceiver module 100 and a socket 200, and the transceiver module 100 corresponds to the socket 200. Specifically, the transmitter module 100 is a module that is conform to the Quad Small Form-factor Pluggable (QSFP) interface, and is configured to be inserted into the socket 200 or pulled out from the socket 200. The socket 200 may be part of a network apparatus, such as, but not limited to, a network switch.

The transceiver module 100 may include a housing 101, a circuit board 104, a pull member 108 and a handle 110. The housing 101 is configured to be inserted into the socket 200 or pulled out from the socket 200, and the housing 101 is composed of an upper casing 102 and a lower casing 112 to form a received space AS. The circuit board 104 is disposed in the received space AS, and is configured to be electrically connected to a connector (not shown in the figures) in the socket 200.

The pull member 108 may have a U-shape structure, and the pull member 108 is fixedly connected to the handle 110. There may be two guiding slots 1121 formed on the opposite two side walls of the housing 101 respectively, so that the pull member 108 is movable relative to the housing 101 along the guiding slots 1121 when connected to the housing 101. In this embodiment, the pull member 108 has two long plate-shaped structures 1081 extending along a first axis AX1 (the long axis). Furthermore, the pull member 108 may further have an engaging structure 1082 connected to the plate-shaped structure 1081.

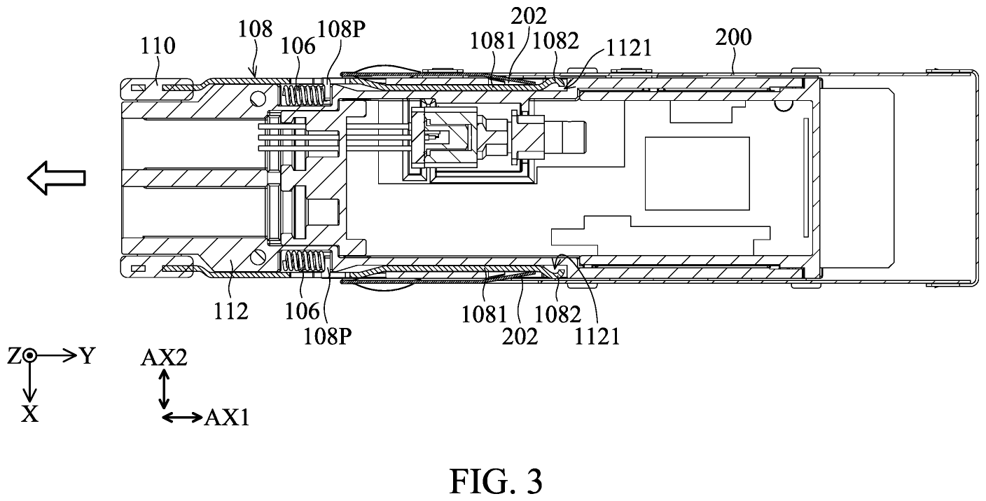

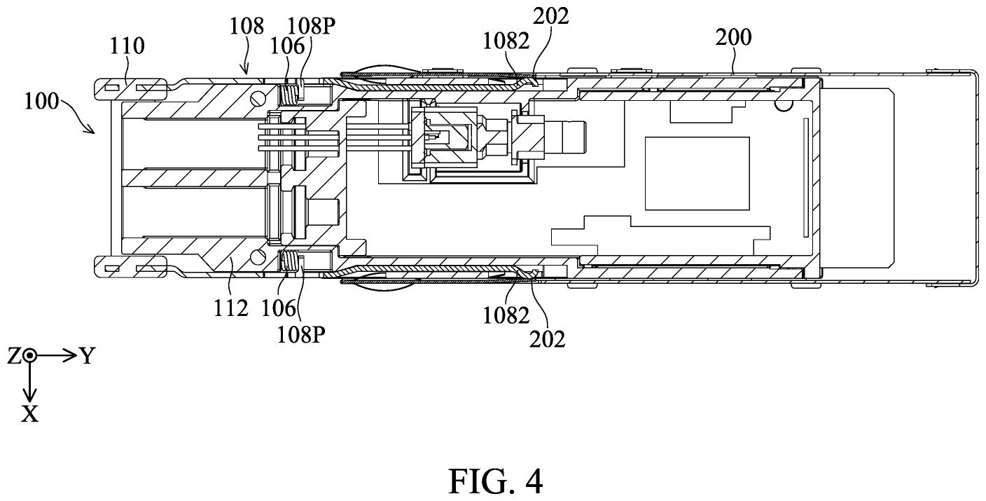

Next, please refer to FIG. 2 to FIG. 4. FIG. 3 is a cross-sectional view of the transceiver apparatus 50 along the line A-A in FIG. 1 according to an embodiment of the present disclosure, and FIG. 4 is a schematic diagram illustrating that the transmitter module 100 is disconnected from the socket 200 according to an embodiment of the present disclosure. As shown in FIG. 2 and FIG. 3, the transmitter module 100 may further include two elastic elements 106, such as springs, disposed between the lower casing 112 and the pull member 108. Specifically, the pull member 108 further has at least one protruding portion 108P extending toward the lower casing 112 so as to contact one end of the elastic element 106, and the other end of the elastic element 106 contacts the lower casing 112.

Furthermore, as shown in FIG. 2 and FIG. 3, each of the opposite side walls of the socket 200 on the left and right sides has a limiting structure 202. The limiting structure 202 is, for example, an elastic plate-shaped body, but it is not limited thereto. As shown in FIG. 3, the limiting structure 202 is configured to limit the engaging structure 1082 to be in the initial position (the engaging position) in FIG. 3.

When the user pulls the handle 110 and applies a force in the direction of the arrow in FIG. 3, the handle 110 drives the pull member 108 to move along the guiding slots 1121 from a first position in FIG. 3 to a second position in FIG. 4. At the same time, the engaging structure 1082 moves from the initial position in FIG. 3 to a release position in FIG. 4. In the procedure of movement, the engaging structure 1082 is in contact with the limiting structure 202, and because the elasticity of the limiting structure 202 is greater than the elasticity of the engaging structure 1082, the limiting structure 202 is pushed outward along a second axis AX2 (the transverse axis) so as to release the engaging structure 1082. Therefore, the transmitter module 100 can be separated from the socket 200. In this embodiment, the second axis AX2 is perpendicular to the first axis AX1.

In addition, during the above-mentioned procedure of movement, the elastic element 106 is squeezed by the protruding portion 108P to generate an elastic force, so when the user no longer applies the force to the handle 110, the elastic force drives the pull member 108 to return to the aforementioned initial position.

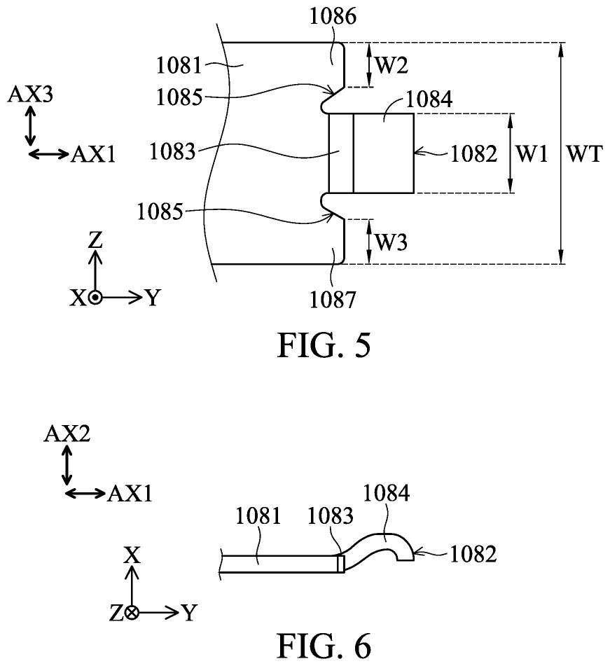

Next, please refer to FIG. 5 and FIG. 6. FIG. 5 is an enlarged diagram of the pull member 108 when viewed along the second axis AX2 according to an embodiment of the present disclosure, and FIG. 6 is an enlarged diagram of the pull member 108 when viewed along a third axis AX3 (the short axis) according to an embodiment of the present disclosure. In this embodiment, the third axis AX3 is perpendicular to the first axis AX2 and the second axis AX2. For example, the first axis AX1 is parallel to the Y-axis, the second axis AX2 is parallel to the X-axis, and the third axis AX3 is parallel to the Z-axis. In addition, the engaging structure 1082 has a first curved portion 1083 connected to the plate-shaped structure 1081. As shown in FIG. 6, when viewed along the third axis AX3 (the short axis) which is perpendicular to the first axis AX1 (the long axis), a part of the first curved portion 1083 overlaps the plate-shaped structure 1081.

Based on the above design, the radius of curvature of the first curved portion 1083 can be greater than that of the conventional design. For example, the conventional radius of curvature is 0.5 mm, while the radius of curvature of the first curved portion of the present disclosure can be greater than 0.75 mm. In this embodiment, the radius of curvature of the first curved portion 1083 is 1.05 mm, but it not limited thereto.

Furthermore, the engaging structure 1082 may further have a second curved portion 1084, and the radius of curvature of the second curved portion 1084 is different from that of the first curved portion 1083. For example, the radius of curvature of the second curved portion 1084 is smaller than the radius of curvature of the first curved portion 1083. In this embodiment, the radius of curvature of the second curved portion 1084 may be 0.8 mm, but it not limited thereto.

It should be noted that, in this embodiment, the thickness of the engaging structure 1082 is uniform, but in other embodiments, the thickness of the engaging structure 1082 may be non-uniform. When the thickness of the engaging structure 1082 is non-uniform, the radius of curvature of the first curved portion 1083 may be increased, so that the engaging structure 1082 may be easily detached from the limiting structure 202.

As shown in FIG. 5, the width W1 of the engaging structure 1082 in the third axis AX3 (the short axis) is between 2 mm and 3 mm, but it is not limited thereto. In addition, in this embodiment, the plate-shaped structure 1081 may form two notches 1085, and the engaging structure 1082 is located between the two notches 1085.

Furthermore, the plate-shaped structure 1081 has a first side portion 1086 and a second side portion 1087, the first side portion 1086 and the second side portion 1087 respectively have a width W2 and a width W3 in the third axis AX3 (the short axis), and the sum of the width W2 and the width W3 (the total width) is less than half of the width WT of the plate-shaped structure 1081 in the third axis AX3.

In this embodiment, the width W2 is equal to the width W3, but it is not limited thereto. In other embodiments, the width W2 may not be equal to the width W3. In addition, the two notches 1085 are formed between the first side portion 1086 and the second side portion 1087.

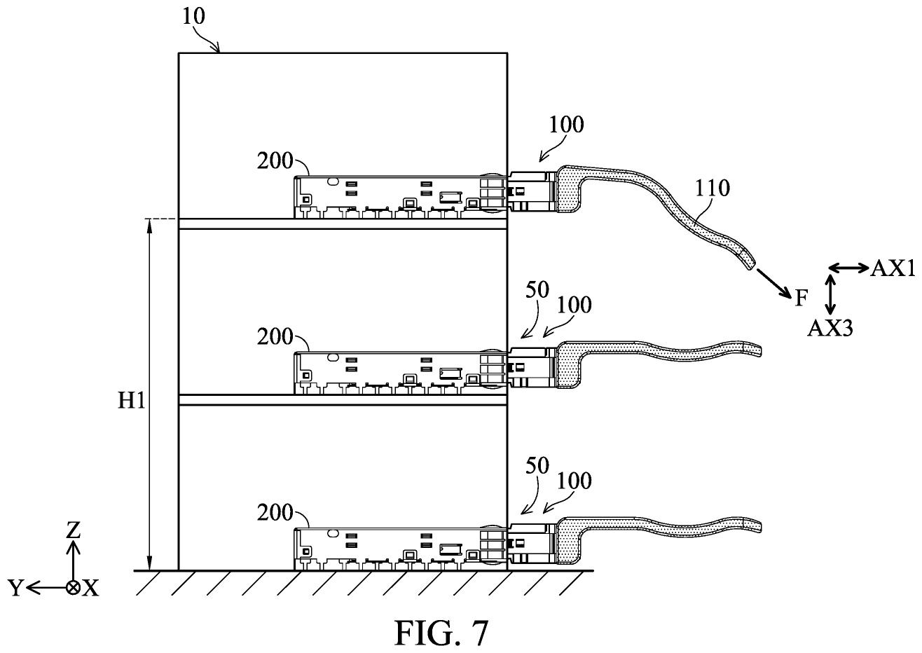

Next, please refer to FIG. 7, which is a schematic diagram of a network apparatus 10 disposed on the ground according to an embodiment of the present disclosure. The network apparatus 10 may include multiple sets of the transceiver apparatus 50, stacked along the direction of the third axis AX3, and the height H1 of the uppermost transceiver apparatus 50 is at least 4.5 feet. When the user wants to pull out the uppermost transceiver module 100, he/she can pull the handle 110 and provide a pulling force F to pull out the transceiver module 100 from the socket 200.

It should be noted that the pulling force F is not parallel to the first axis AX1 (such as the horizontal direction). For example, the included angle between the pulling force F and the first axis AX1 is 20 to 50 degrees. Based on the above-mentioned designs of the plate-shaped structure 1081 and the engaging structure 1082 of the present disclosure, the user can easily and smoothly pull out the uppermost transceiver module 100 without the problem that the conventional design is easily stuck and cannot be pulled out, and the pulling force F can be smaller compared with the conventional design, allowing the user to easily pull out the transceiver module 100.

In conclusion, the present disclosure provides a transceiver apparatus 50, which includes a transceiver module 100 and a socket 200 that can be engaged with each other. The pull member 108 of the transceiver module 100 has at least one engaging structure 1082 configured to be engaged with the corresponding limiting structure 202 on the socket 200. Two notches 1085 can be formed on the plate-shaped structure 1081 of the pull member 108, which are located on both sides of the engaging structure 1082. This design can make the first curved portion 1083 of the engaging structure 1082 have a larger radius of curvature than that of the conventional designs.

Based on the design of the present disclosure, the user can easily and smoothly pull out the transceiver module 100 which is disposed at a certain height, without the problem that the conventional design is stuck and cannot be pulled out, and the required pulling force F can also be smaller than the conventional designs, allowing the user to easily pull out the transceiver module 100.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. A transceiver module, comprising:
a housing, having a received space and a guiding slot;
a circuit board, disposed in the received space; and
a pull member, connected to the housing, and the pull member has:
a plate-shaped structure, extending along a long axis; and
an engaging structure, having a first curved portion connected to the plate-shaped structure;
wherein the plate-shaped structure forms two notches, and the engaging structure is located between the two notches.

2. The transceiver module as claimed in claim 1, wherein when viewed along a short axis which is perpendicular to the long axis, the first curved portion overlaps the plate-shaped structure.

3. The transceiver module as claimed in claim 1, wherein a radius of curvature of the first curved portion is greater than 0.75 mm.

4. The transceiver module as claimed in claim 2, wherein a width of the engaging structure in the short axis is between 2 mm and 3 mm.

5. The transceiver module as claimed in claim 2, wherein the plate-shaped structure has a first side portion and a second side portion, and a total width of the first side portion and the second side portion in the short axis is less than half of a width of the plate-shaped structure in the short axis.

6. The transceiver module as claimed in claim 5, wherein the two notches are formed between the first side portion and the second side portion.

7. The transceiver module as claimed in claim 1, wherein a thickness of the engaging structure is non-uniform.

8. The transceiver module as claimed in claim 1, wherein the engaging structure further has a second curved portion, and a radius of curvature of the second curved portion is different from a radius of curvature of the first curved portion.

9. The transceiver module as claimed in claim 8, wherein the radius of curvature of the second curved portion is smaller than the radius of curvature of the first curved portion.

10. A transceiver apparatus, comprising:
a socket, having a limiting structure; and
a transceiver module, corresponding to the socket, and the transceiver module comprising:
a housing, having a received space and a guiding slot, wherein the housing is configured to be inserted into the socket or pulled out from the socket;
a circuit board, disposed in the received space and configured to be electrically connected to a connector in the socket; and
a pull member, connected to the housing, and the pull member having:
a plate-shaped structure, extending along a long axis; and
an engaging structure, having a first curved portion connected to the plate-shaped structure;
wherein the plate-shaped structure forms two notches, and the engaging structure is located between the two notches.

11. The transceiver apparatus as claimed in claim 10, wherein when viewed along a short axis which is perpendicular to the long axis, the first curved portion overlaps the plate-shaped structure.

12. The transceiver apparatus as claimed in claim 10, wherein a radius of curvature of the first curved portion is greater than 0.75 mm.

13. The transceiver apparatus as claimed in claim 11, wherein a width of the engaging structure in the short axis is between 2 mm and 3 mm.

14. The transceiver apparatus as claimed in claim 11, wherein the plate-shaped structure has a first side portion and a second side portion, and a total width of the first side portion and the second side portion in the short axis is less than half of a width of the plate-shaped structure in the short axis.

15. The transceiver apparatus as claimed in claim 14, wherein the two notches are formed between the first side portion and the second side portion.

16. The transceiver apparatus as claimed in claim 10, wherein a thickness of the engaging structure is non-uniform.

17. The transceiver apparatus as claimed in claim 10, wherein the engaging structure further has a second curved portion, and a radius of curvature of the second curved portion is different from a radius of curvature of the first curved portion.

18. The transceiver apparatus as claimed in claim 17, wherein the radius of curvature of the second curved portion is smaller than the radius of curvature of the first curved portion.
